(19) United States
(12) Patent Application Publication
(10) Pub. No.: US 2025/0241391 A1
(43) Pub. Date: Jul. 31, 2025

(54) SYSTEMS AND METHODS FOR GARMENT FIT GAP MEASUREMENT

(71) Applicant: Regents of the University of Minnesota, Minneapolis, MN (US)

(72) Inventors: Bradley Thomas Holschuh, Minneapolis, MN (US); Nicholas Donald Holschuh, Minneapolis, MN (US); Alreza Golgouneh, Minneapolis, MN (US); Justin Geeslin, Minneapolis, MN (US)

(21) Appl. No.: 19/038,242

(22) Filed: Jan. 27, 2025

Related U.S. Application Data
(60) Provisional application No. 63/625,157, filed on Jan. 25, 2024.

(51) Int. Cl. A41H 1/02; G01B 11/28; G01B 17/00

(52) U.S. Cl. CPC A41H 1/02; G01B 11/28; G01B 17/00

(57) ABSTRACT

A system and method for measuring an air gap between a positive ease garment and an internal structure including a first scanner of a first frequency range; a second scanner of a second frequency range co-located with the first scanner, wherein the second frequency range is different from the first frequency range such that the first scanner and the second scanner differentially reflect off the positive ease garment and the internal structure; and at least one processor in communication with a memory, the memory comprising instructions which, when executed by the processor, cause the processor to perform: receiving a first flight time from the first scanner and a second flight time form the second scanner; determining a difference between the first flight time and the second flight time; estimating, based on the difference between the first flight time and the second flight time, an air gap distance.

### CROSS-REFERENCE TO RELATED APPLICATIONS

This present application claims the benefit of U.S. Provisional Application No. 63/625,157, filed Jan. 25, 2024, which is incorporated herein by reference in its entirety.

### BACKGROUND

Reliable quantification of real-time fit characteristics of a non-translucent garment on the body is important in many contexts. Specifically, the gap between the wearer and the garment, referred to as “ease,” is important in as varied fields as aeronautics, diving, fashion, and exosuit/exoskeleton design. Currently, measuring garment ease is possible in some limited cases in which the garment is form fitting (e.g., zero or negative ease). The ability to measure the ease between a positive ease garment and the body, both statically and dynamically, would represent a significant advancement in remote and non-invasive measurement technologies and would provide a useful diagnostic tool for the design of wearable products and/or systems.

An effective gap measurement would beneficially inform the design of clothing with a positive ease by revealing how a wearer interacts with the garment in both static and dynamic tasks. Further, such a measurement vastly improve the ability to design and evaluate functional garments which must be oversized for functional reasons or which require precise fit over complex body geometries (e.g., hazmat suits, dive suits, space suits, etc.). Seeing how, and where, a wearer interacts with the interior surface of an oversized garment can inform the functional properties, comfort, and aesthetic experience of wearing the garment. In addition, being able to take the measurement remotely and/or non-invasively eliminates the need for a body-worn or garment-embedded sensors.

Currently there is no method to accurately, non-invasively, and directly determine air-gap distances in loose fitting body worn garments. Scanning systems that are commercially available tend to either scan only the surface, e.g., infrared (IR) or light and detection ranging (LIDAR) systems, or only the underlying body surface, e.g., millimeter wave scanners at airports, but not both, making it impossible to determine whether an air-gap exists and, if so, to determine its location and magnitude. Other approaches, such as pressure-sensors arranged on the interior of a garment, can measure contact between the wearer and the garment but do not measure a quantity of space—that is, they indicate when there is impingement, but not when there is extra space or a quantity of clearance between the wearer and the garment.

### SUMMARY

Examples presented herein relate to a sensor system. The sensor system comprises a fixed arrangement of a first emitter and a first sensor, both of which have a specific type. It also includes a second emitter and a second sensor, also of a specific type, mechanically connected in a fixed positional relationship.

Optionally, in addition to the sensor system described above, the system can also include a processor that can make the first emitter send out a signal and receive data from the first sensor about the reflection of this signal. It can also receive data from the second sensor about the reflection of a signal sent by the second emitter. The processor performs a Fast Fourier transform on the data from both sensors to determine two distances and then calculates the ease based on the difference between these distances. The first type of emitter and sensor could be millimeter wave, the second type could be infrared or ultrasound, and the system might include a third emitter and sensor of a different type. Additionally, the system can have a display to show a map of the ease across an area, and the components are colocated.

According to a second aspect, a method involves method for measuring ease involves sending out signals from two different types of emitters and collecting their reflections using corresponding sensors. The reflections are analyzed using a Fast Fourier transform to determine two distances, and the ease is calculated based on the difference between these distances, with all components held in a fixed positional relationship.

In addition to the method described above, the first type of emitter and sensor can be millimeter wave, the second type can be infrared with a variable wavelength or ultrasound, and there might be a third type of emitter and sensor used in a similar way. The method can also include determining and displaying the distribution of ease across an area, ensuring the components are colocated, training a logistic regression model to correlate fabric-based layer distance with ease, and continuously mapping ease over time during movement.

According to a third aspect, a system for measuring ease includes a sensor fusion unit consisting of an infrared scanner and an ultrasonic scanner. It also includes a millimeter wave scanner located in the same position as the sensor fusion unit. The system is connected to at least one processor that receives flight time data from the sensor fusion unit and the millimeter wave scanner. By comparing the flight times, the processor estimates the amount of ease between the garment and the internal structure.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is example of ease between an external garment and an underlying body.

FIG. 2 is a typical three-dimensional (3D) body scan produced using an infrared (IR) scanner.

FIG. 3 is an example of a scan produced using millimeter-wave body scanning technology.

FIG. 4 is a schematic of a system for air gap measurement according to embodiments of the present disclosure.

FIG. 5 is a circuit block diagram of an example IR range sensor usable in a system such as the one shown in FIG. 4.

FIG. 6 is an example system function of an ultrasound (US) sensor.

FIG. 7 shows the functional architecture of an example millimeter wave radar system.

FIGS. 8A-8C are a series of graphs of the FMCW range of measurement errors.

FIGS. 9A-9C are a series of graphs showing the difference between the measured range and the actual range of the graphs of FIG. 8

FIGS. 10A-10D are a series of graphs of the corrected measurement of the FMCW range of measure of FIGS. 8A-8C.

FIG. 11 is a plot of calibration measurement for the US sensors.

FIG. 12 is a plot of calibration measurement for the IR sensors.

FIG. 13 is an example gap measurement setup.

FIG. 14 is a diagram of the system of another example sensor fusion system.

FIG. 15 is a block diagram of another example sensor fusion system.

### DETAILED DESCRIPTION

Disclosed herein are systems and methods for garment fit gap measurement, including systems and methods to remotely determine garment fit using co-located multi-band scanning. As discussed herein, the “fit” of the garment refers to the difference, e.g., an air gap distance, between an exterior body surface and the external garment surface at a given body location, generally referring to garments that are larger than a body segment they cover, e.g., garments with positive garment ease.

Existing garment and/or body-scanning technologies used in the apparel industry rely on direct surface measurements, using a combination of visual light, infrared (IR), and/or ultrasonic (US) direct surface mapping. These systems can only measure and quantify the first surface that is encountered, either the outer surface of the garment, or the body of a wearer of the garment, if uncovered. Millimeter wave scanning technologies are a body scanning technology that is increasing in use to “see through” clothing of wearers to detect concealed objects. These systems each offer the ability to scan either the exterior clothing surface, in the case of IR/US scanners, or the underlying body surface, in the case of millimeter wave scanners.

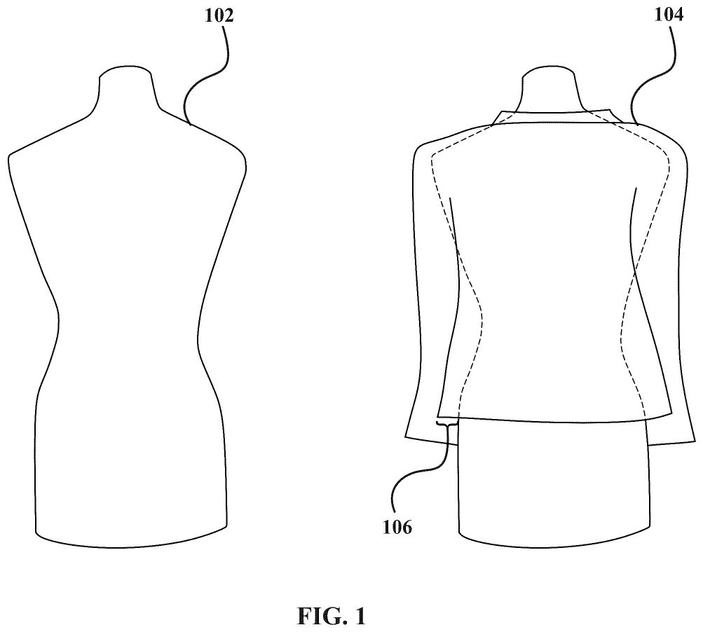

FIG. 1 is example of ease 106 between an external garment 104 and an underlying body 102. Due the difference in size and shape between external garment 104 and underlying body 102, an air gap exists between the external garment 104 and underlying body 102 when the garment is worn. This air gap defines the ease 106 of the garment, and in particular is positive ease as the size of the external garment 104 is greater than that of the underlying body 102.

It is useful in many circumstances to know the amount of ease 106 between an external garment 104 and an underlying body 102. For example, the amount of ease at different parts of the cut of a garment can vary even between garments having the same nominal size. It can be helpful for a person to know not only their size, but also which types of cuts result in undesirably high or low levels of ease in different parts of the garment. Systems described herein can measure the ease 106 between an external garment 104 and an underlying body 102 by taking an air gap measurement, which can be used to tailor garments, identify poor fit, or suggest other garments that may have better fit based upon the amount of ease 106 throughout the garment.

The interaction of garment materials with different types of waves-IR, ultrasound, and millimeter waves, for example—varies depending on the material's properties and the specific wavelength of the waves involved. Garment materials, particularly those made of synthetic fibers like polyester, nylon, and spandex, tend to reflect and scatter IR radiation to some extent. The degree of reflection or absorption depends on the fabric's composition, color, and thickness. Garment materials can both reflect and transmit ultrasound waves. Thicker or denser fabrics may reflect more ultrasound waves, while thinner or less dense materials may allow some penetration. Millimeter waves used in security scanning systems can generally penetrate clothing materials without revealing anatomical details. Millimeter wave scanners are designed to detect concealed objects under clothing while respecting privacy.

In embodiments described below, combinations of emitters and sensors can be used to detect the contours of both the underlying body 102 and the external garment 104 to determine ease 106. One sensor/emitter pair can be of a first type (say, millimeter wave) while another sensor/emitter pair can be of a second type (say, ultrasound or infrared). Typically the first type will be one that can see the underlying body 102 while the other can see the external garment 104, based on what types of materials are transmitted, absorbed, or reflected at each interface. For example, the first type can be an emitter/sensor pair that transmits through common fabrics and is reflected by the underlying body 102, while the second type can be an emitter/sensor pair that is reflected by an external garment 104.

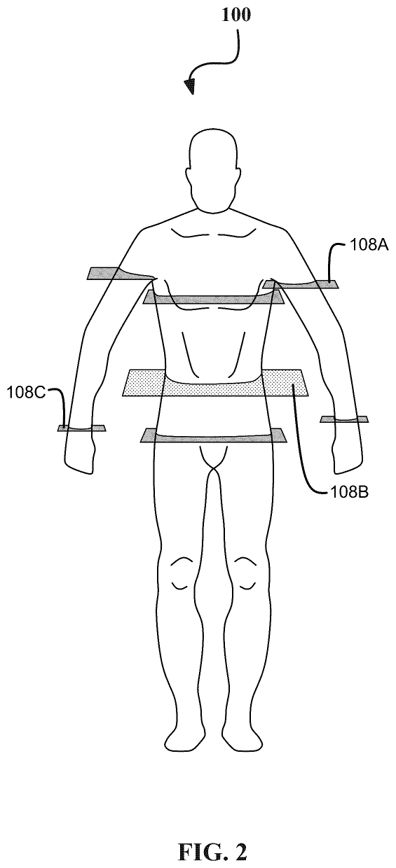

FIG. 2 is a typical three-dimensional (3D) body scan 100 produced using an infrared (IR) scanner. IR scanning works by detecting the thermal radiation emitted by objects and surfaces. All objects emit IR radiation as a function of their temperature. Infrared scanners use sensors to capture this radiation, converting it into a visual representation where different colors or shades represent variations in temperature. This technology allows for non-contact temperature measurement and is used in various applications, including thermal imaging, medical diagnostics, and industrial inspections.

FIG. 2 shows multiple circumferential scans at various locations, such as a shoulder circumference 108A, a waist circumference 108B, and a wrist circumference 108C. In embodiments, a scan can be done at a discrete region of the body, such as the circumferences 108A-108C. Alternatively, 2-D or 3-D regions of the underlying body (102, FIG. 1) can be collected as a whole.

Using infrared (IR) radiation to measure underlying layers or objects has limitations. IR primarily captures surface properties, making it challenging to assess subsurface conditions accurately. Limited penetration depth, material variability, and interference from environmental factors can affect the accuracy of measurements.

IR in isolation has limited penetration depth and can be affected by factors like material composition and environmental conditions. Interference from ambient IR sources and the need for precise calibration can further impact the accuracy of measurements.

Ultrasound (US) scanning works by emitting high-frequency sound waves (ultrasound) into the body or an object and detecting the echoes that bounce back. The time it takes for these echoes to return is used to create detailed images of internal structures or surfaces. Ultrasound is commonly used in industrial applications for inspecting materials and structures. It is non-invasive and does not involve ionizing radiation.

Ultrasound has limitations when measuring underlying layers, including limited penetration depth, challenges with reflective boundaries, and the impact of material properties on accuracy. It may not provide sufficient resolution for fine features and can be obstructed by certain structures. Skilled operators are needed, and variations in anatomy can affect results. Using ultrasound for surface layer measurement poses challenges due to features such as surface irregularities, reflections, and refractions which can hinder accurate measurements.

Bodies tend to absorb infrared (IR) radiation and ultrasound waves to varying degrees, depending on the specific wavelengths and the tissues involved. In general, human tissues, especially those containing water, tend to absorb IR radiation. Human tissues also interact with ultrasound waves by scattering, absorbing, and reflecting them to some extent. The degree of absorption and reflection depends on tissue density and acoustic properties.

Unlike IR and ultrasound, millimeter waves can pass through clothing and certain materials, but they interact with the surface of the skin, reflecting off it. This is why millimeter wave scanners can detect objects concealed under clothing. So, while bodies do absorb IR and ultrasound to some extent, millimeter wave scanning is designed to interact more with surfaces and can provide a better contour of the underlying body 102.

As will be appreciated from the foregoing description, a combination of sensor modalities can be used to provide high- and low-resolution imaging of different types of materials, including a human body and various types, materials, and colors of garments on that body. Such a combination can be used to identify the outwardly-oriented face of any particular material that is reflective to the particular type of signal that is emitted towards it.

Disclosed herein is a technique for remotely measuring the gap between an external wearable device or clothing surface and an underlying body surface which may be visually-obstructed, referred to herein as the garment-body “air gap” or “ease” that commonly occurs in positive ease garments. Positive ease garments generally refers to those garments that are larger in dimension than the underlying body dimension, while the air gap or ease refer to the amount of the size difference between the garment and the body. The method disclosed herein is both non-invasive and direct, without the need for post-hoc simulation or any physical sensors to be placed between the wearer and the garment. The systems and methods disclosed herein for accomplishing remote and non-invasive gap measurement include, in embodiments, co-located multi-band electromagnetic (EM) spectrum scanners. Each scanner may consist of both an emitter and a detector, and be configured to emit and/or detect a specific EM frequency band.

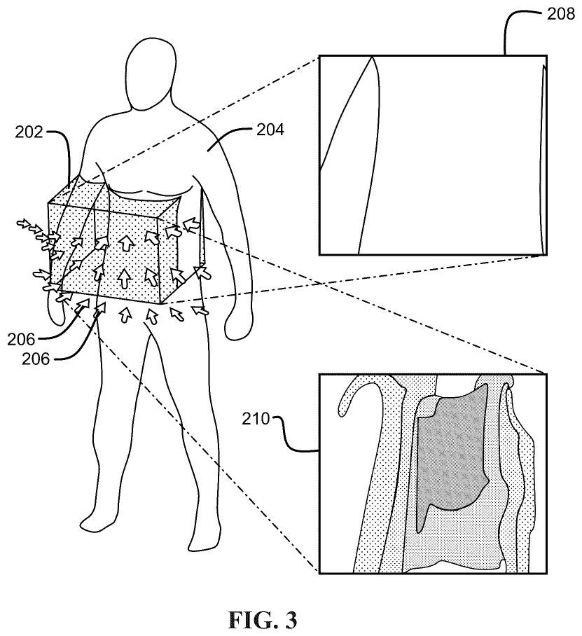

FIG. 3 is an example of a scan produced using millimeter-wave body scanning technology. Millimeter-wave body scanning is capable of measuring the presence of a concealed object underneath a piece of loose fitting clothing, for example, and is commonly used for this purpose.

Millimeter wave scanning works by emitting low-power, non-ionizing electromagnetic waves in the millimeter wave frequency range, typically around 30 to 300 GHz. These waves are directed towards an object or person. A detector then analyzes the reflected waves to create a detailed image, highlighting anomalies or concealed items under clothing. Millimeter wave scanners are commonly used in security screening at airports and other sensitive locations to detect hidden objects. Millimeter wave scanning has limitations that include its limited image resolution, susceptibility to environmental interference, and concerns about privacy, cost, and operator training. Millimeter waves reflect from a material depending upon its electrical properties. Metals and metal-coated surfaces are highly reflective, as well as certain dielectric materials. Water is also reflective to millimeter waves, such as the water in the human body, such that the contours of an underlying body (e.g., 102) are reflective in some millimeter wave bands. In some methods contemplated herein, a person can use reflective body paint, wraps, or other materials that enhance millimeter-wave reflectiveness or improve its accuracy.

FIG. 3 shows an exaggerated example of a region 202 of a torso of a body 204. Arrows 206 indicate a level of ease determined by a sensor system as described above. Each arrow is a vector, having a direction and a magnitude. As shown in FIG. 3, the magnitude is higher in some regions, which is indicative of higher ease in that portion of the region 202.

Millimeter wave scan 208 and infrared scan 210 are shown in exploded view from FIG. 3. As shown in FIG. 3, the millimeter wave scan 208 shows some contouring of the torso of the body 204. The infrared scan 210 shows an intensity of returned infrared light. As is apparent from infrared scan 210, some of the signal from the wearer may be from body heat from the body 204. It may therefore be useful to obtain multiple measurements (e.g., a scan with the infrared emitter off, and another with the infrared emitter on, to determine the amount of infrared light that is actually reflected).

Other methods which have been considered to measure body-garment ease through physical contact is to either place physical sensors, e.g., contact or pressure sensors, on the wearer's body or on the interior surface of the garment, such that contact between the body and the garment triggers a sensor response. However, these techniques do not provide any information about total ease; rather, they provide information solely about whether ease is zero or non-zero.

Another considered method attempts to post-hoc model garment interactions is by pairing real-time scans of the garment surface with previously created finite element modeling (FEM) or biomechanical models of the individual to infer changes in fit and/or contact. Direct contact sensing methods are susceptible to sensor artifacts (such as bending or stretching of the sensor during movement creating a sensor response that can be confused with garment contact), are limited in spatial resolution based on the number and location of the physical sensors, cannot quantify changes in fit that do not result in direct contact (e.g., if the air gap distance changes, but does not result in contact between the garment and body, no sensor response will be measured), and are physically invasive due to necessarily being physically placed between the body and the garment in order to detect contact and/or pressure. Inferential, post-hoc modeling efforts are imprecise and computationally intensive, and ultimately can only guess or infer the actual dynamics between the body and the garment because no direct measurement or verification is achievable.

In contrast to these approaches, a completely stand-off sensing system and method are contemplated that uses acoustic and/or optical signals that reflect at the different surfaces. By co-positioning combinations of sensors, different types of sensed data giving disparate pieces of information can be used to generate signals that indicate garment ease, which cannot be detected either directly or indirectly by such sensors when used in isolation. Combining these data, and accounting for the different propagation speed of each type of signal, can be used to create detailed data regarding ease in a garment or a portion thereof.

In some embodiments, two scanners of significantly different frequency ranges are designed to differentially reflect off the garment and body surface, respectively. By co-locating the scanners and directing each to the same garment/body location, and by measuring the difference in flight time between the emission and the reception of each EM or acoustic scan, it is possible to determine the relative distance of both the garment and the body surface, with the difference in flight time providing a non-invasive estimate of the gap between the surfaces. This method can be done at a distance, non-invasively, and can quantify gaps between the garment and the body, even if the garment is not otherwise optically transparent.

In some embodiments, the use of co-located multi-band scanners designed to differentially reflect off the garment and body surface includes the use of three scanners of significantly different frequency ranges in the form of infrared (IR) and ultrasound scanners like traditional surface scanners, and frequency-modulated continuous wave (FMCW) millimeter-wave scanners. By co-locating the scanners and directing each to the same shared garment and body location, it is possible to determine the relative distance of both the exterior garment surface and the underlying body surfaces. The emitted signal can be sent out so that reflections are received simultaneously, or in some embodiments where acoustic reflections are used there may be post-processing of the returned reflections to account for their slower propagation speed. The emitters and sensors used to collect such data can be held in a fixed mechanical position relative to one another. In this way, the distance between the emitters and sensors is known and appropriate adjustment can be made to determine the distance that the received reflections traveled en route to the target and back. For example, the emitters and sensors can be substantially collocated (or arranged at the same place) or they may be set forward or back from one another, or side-to-side.

The sensor systems and methods described above thus provide a quantifiable estimate of the gap (e.g., ease 106) between the surfaces (e.g., underlying body 102 and external garment 104). The method disclosed herein is both non-invasive and direct, without the need for post-hoc simulation or any physical sensors to be placed between the wearer and the garment. Further, it can be done at a distance, non-invasively, safely, and can quantify gaps between the garment and the body, even if the garment is not otherwise optically transparent. In some embodiments, there may be three or more emitter/sensor pairs, which can be used on different types of garments that may be absorptive or transmissive to other types of sensors. For example, a highly sound-absorptive knit pattern may not reflect ultrasound signal, but may still be highly reflective to infrared signal. In still further embodiments, three or more types of emitter and sensor pairs can be used in the same scan, with the multiple different sensor types providing additional data that can be used to reduce statistical error in the detection of ease.

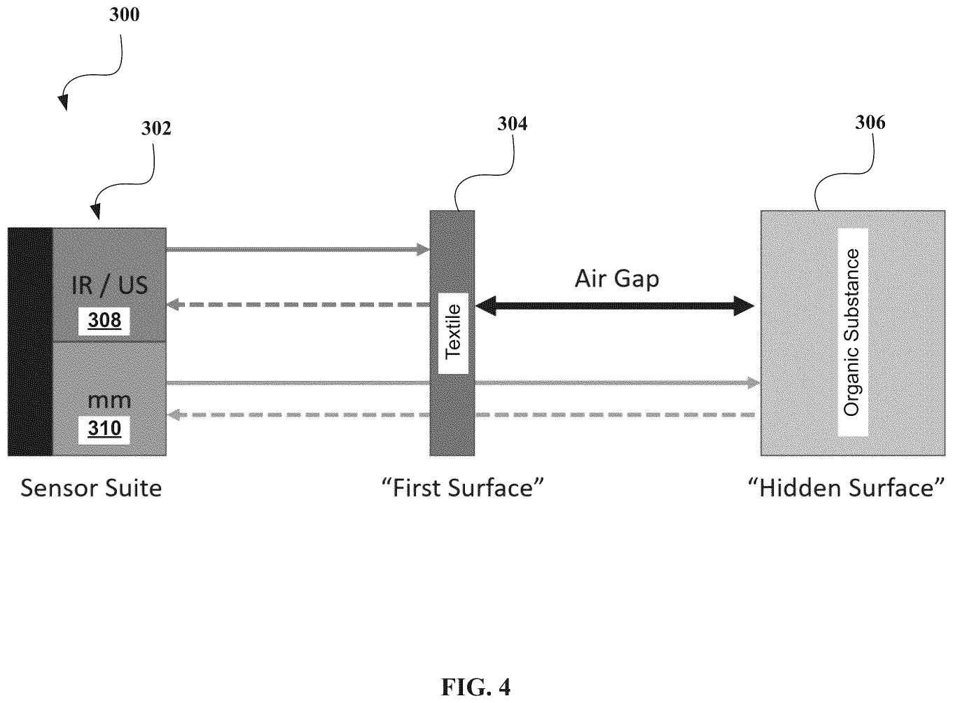

FIG. 4 is a schematic of a system 300 for air gap measurement according to embodiments of the present disclosure. The schematic of FIG. 4 illustrates the physical principle of the proposed multi-band remote scanning method. The multi-band sensor 302 emits at least one of an IR and ultrasonic (US) signal 308 and, additionally, a millimeter wave signal 310. The IR/US band reflects off the first surface 304 (textile surface) whereas the millimeter wave band reflects off the second surface 306 (body surface). A comparison of the measurements in the same location can therefore quantify the air gap in that location. The example system presented in FIG. 4 advantageously makes use of commercially available range sensors spanning three different spectra: millimeter wave, IR, and US systems.

This method to non-invasively and remotely quantify the otherwise-unobservable air-gap of a worn garment combines existing technology in novel ways to solve a currently unsolved problem in wearable products and wearable technology. Typical scanning technology uses infrared and/or visible light to detect the surface of objects (e.g., the platform for body or surface scanning systems by Styku®, standard Light Detection and Ranging (LIDAR) systems, or the Occipital Structure Scanner by Structure™). These technologies have submillimeter accuracy but are only capable of measuring the first surface that is encountered by the scan, the exterior garment surface in the context of measuring an air gap, and thus cannot typically provide information about surfaces beyond the initial surface, such as the body of the wearer when the body is obstructed by a body-worn garment. Millimeter wave scanners, like those found at airports to scan passengers as they enter the gate area, are capable of penetrating through clothing to measure the underlying body surface without issue but provide no useable information about the surfaces penetrated, e.g., the garments. In some embodiments, the infrared emitter can operate at a variety of wavelengths, or at a broadband spectrum of wavelengths, to avoid challenges that could otherwise occur if the infrared wavelength used were absorbed by the particular fabric worn by the user.

The system 300 of FIG. 4 uses both scanning technologies in coordination and co-location with each other, to scan a specific garment/body location with each device, either simultaneously or consecutively, providing a real-time estimate of both the garment surface and the body surface. The infrared/visible light emission from the IR/US source 308 will reflect off the garment surface and give a distance estimate of the garment surface, and the millimeter-wave emission from millimeter wave source 310 will transmit through the garment surface and reflect off the body surface, giving a distance estimate of the body surface. These two measurements can then be compared, with the difference representing an estimate of the unobservable air-gap between body and garment surfaces, thereby providing information about the fit of the garment at that moment and in that location.

So long as the target is relatively stationary these two signals can be combined even if taken at different times, so long as the sensor suite 302 has IR/US emitter 308 and millimeter wave source 310 substantially collocated. An example where this type of sensing could be conducted is a prototype garment on a mannequin.

For moving surfaces 304 and 306, detection of Air Gap may involve simultaneous operation of IR/US source 308 and millimeter source 310. An example where this type of sensing could be conducted is detection of Air Gap on an astronaut in trials of a space suit, while the astronaut is moving.

Co-locating sensors offers several advantages, including redundancy for reliable data collection, improved accuracy through data fusion, and the ability to cross-validate and calibrate sensors. It also helps detect faults, capture spatial variability, and mitigate limitations of individual sensors. Co-locating can be advantageous in applications where precision, consistency, and reliability are desired. As described above, the locations do not need to be exactly the same, and can vary (e.g., be intentionally offset) as long as the fixed mechanical or positional relationship between the emitters and sensors is known, such that time-of-flight corrections can be made based upon the distance the signal travels.

Millimeter-wave radar devices have shown the ability to detect concealed objects with relatively high x-y imaging accuracy and these systems have also been explored for distance (e.g., z-axis) range estimation. Such devices can be commercially procured with off the shelf toolboxes designed to support range estimation applications. To provide the range measurement in the mm wave frequency band, the Texas Instruments (TI) IWR1843BOOST2 radar sensor was implemented. This sensor operates between 77 and 81 GHz and is equipped with four receive antennas and three transmit antennas.

It should be understood that while FIG. 4 shows IR/US source 308 and millimeter source 310, the sensor suite 302 also includes sensors capable of detecting each type of reflected signal (shown in dashed lines in FIG. 4). That is, IR/US source 308 is capable of not just sending but also receiving reflected signal. Additional components, such as demodulators, processors, and comparison software can be used to combine the data from such sensors to determine Air Gap.

In some embodiments, the “time of flight” of signal is used to determine the distance to either textile 304 or hidden surface 306. However, different signals will travel at different speed. While IR signal from IR/US source 308 travels at the speed of light, ultrasound emitted at the same sensor will travel at the speed of sound. In ambient conditions, the speed difference between these two could be about a factor of a million. Thus, ultrasound signal received upon reflecting off of textile 304 (or other outer layer) may be delayed compared to the reflected IR or millimeter-wave signal from the same sensor suite 302. Time-of-flight for light and acoustic signal can be calculated separately and combined based on expected speed for each type of signal.

For example, it may be that a diving suit would be tested at low temperature, or underwater. In contrast, a safety harness or exosuit may be tested at ambient room temperature and pressure. These differences in temperature and medium through which the ultrasonic signal is delivered can be taken into account in determining the expected speed of sound and therefore the determined time-of-flight of acoustic signal.

Combining IR and US using sensor fusion may provide advantages over either sensor alone as the two sensors are fundamentally different and work at different frequency ranges. If either sensor fails to measure the distance for any number reasons (e.g., noise issues, wiring disconnections, etc.), using both is helpful to ensure that the distance measurement is successful even in absence of one of the sensors. Additionally, in the frequent event that both sensors successfully provide readings, sensor fusion is able to reduce any associated measurement error.

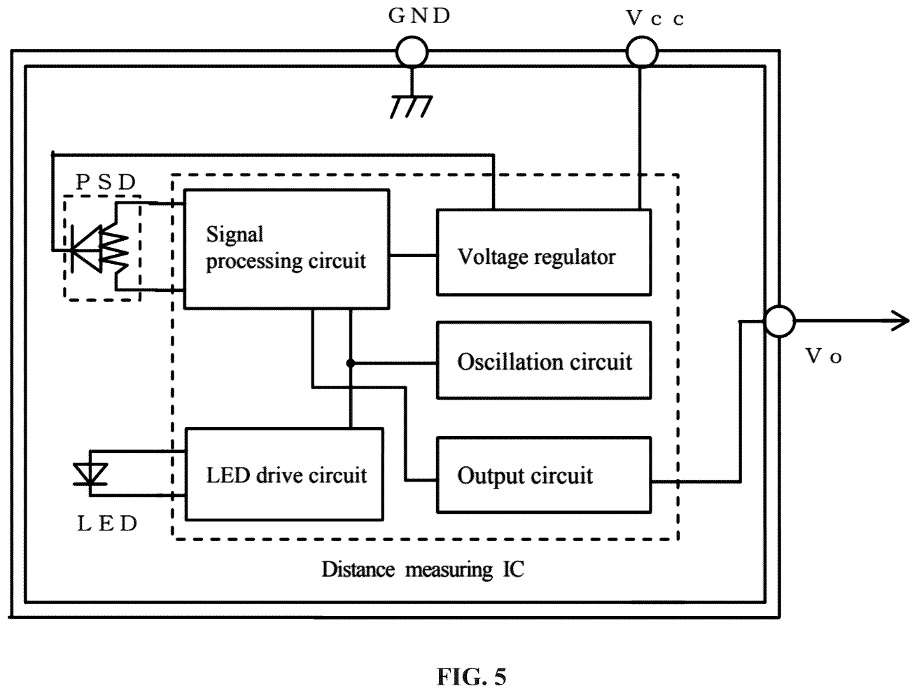

FIG. 5 is a circuit block diagram of an example IR range sensor usable in a system such as the one shown in FIG. 4. IR range sensors are an established technology for first-surface range estimation and used in autonomous or robotic navigation applications. To provide the IR frequency band remote range measurement for the present example, the Sharp infrared sensor (GP2Y0A21YK0F) was used. This sensor is composed of an integrated combination of PSD (position sensitive detector), IRED (infrared emitting diode), and a signal processing circuit. The output of the sensor is an analog signal that can be sampled by an ADC channel to be mapped to objects' proximity. The emitting wavelength range of LED for this sensor is (1=870 nm±70 nm) and the measurement range is 10-80 cm.

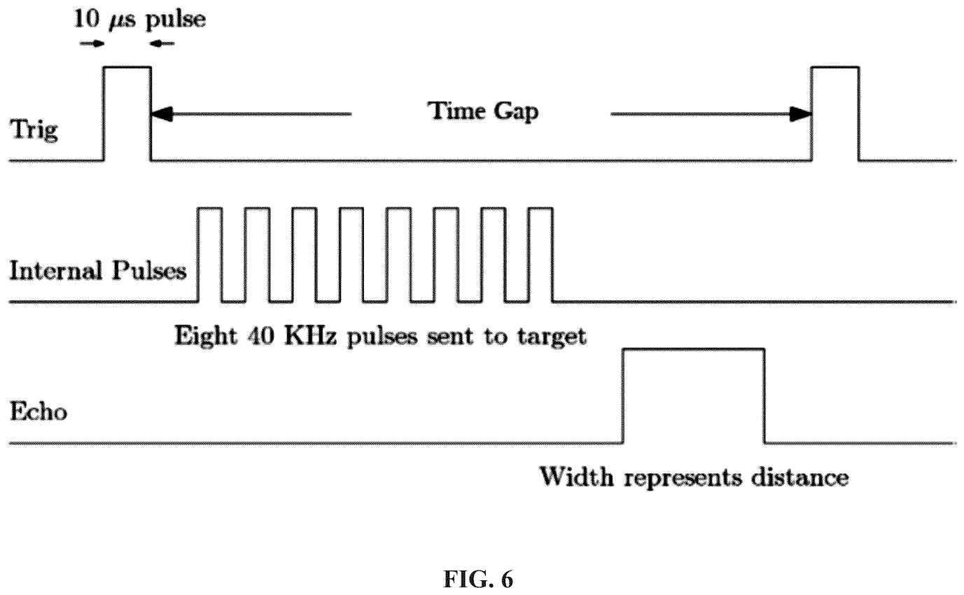

FIG. 6 is an example system function of an ultrasound (US) sensor. Similar to IR range sensors, US range sensors are a mature technology for range estimation applications. The Ultrasonic Ranging Module HC-SR04 was used in this example to provide remote distance measurement of the first-encountered surface within the ultrasound frequency band as a complement to the IR range sensor.

As described above with respect to FIG. 4, the sensor suite 302 includes IR/US emitter 308 and millimeter-wave emitter 310, and each of these can include a detector or sensor (not separately called out in FIG. 4) that is collocated with the emitters within the sensor package 302. The sensors collect the reflected US, IR, and millimeter-wave signals, depicted in that figure with dashed lines.

FIG. 6 shows the signal detected in such a system along a common time axis. This example sensor module is composed of transmitter (Trig) and receiver (Echo) components. The SR04 ultrasonic sensor of this example requires a trigger 5v pulse of at least 10 us to initiate the measurement. It then transmits 8 cycles of ultrasonic burst at 40 kHz and waits for the reflected ultrasonic burst. When the sensor of this example detects the reflected ultrasonic burst, it sets the Echo pin to high and measures the width (Ton) of the Echo pin to determine the distance. The distance between the sensor and the object can be calculated by dividing the width of the Echo pulse in us by a constant of 58 (the speed of sound in air) which accounts for the round trip of the ultrasonic pulse.

This constant is derived by taking the speed of sound in air at room temperature (around 20 degrees Celsius or 68 degrees Fahrenheit), which is approximately 343 meters per second (m/s) or 0.0343 centimeters per microsecond (cm/μs). Since the pulse travels to the object and back, it is necessary to divide the time it takes for the round trip by 2 to get the one-way time. Therefore, the formula for distance in centimeters is: Distance (cm)=(Time (μs)/2)×Speed of Sound (cm/μs). This equation can be simplified by replacing the speed of sound with its approximate value, which yields: Distance (cm)≈(Time(μs)/2)×0.0343 cm/μs. Rounded to a convenient approximation, the commonly used factor of 58 is arrived at: Distance (cm)≈Time(μs)/58.

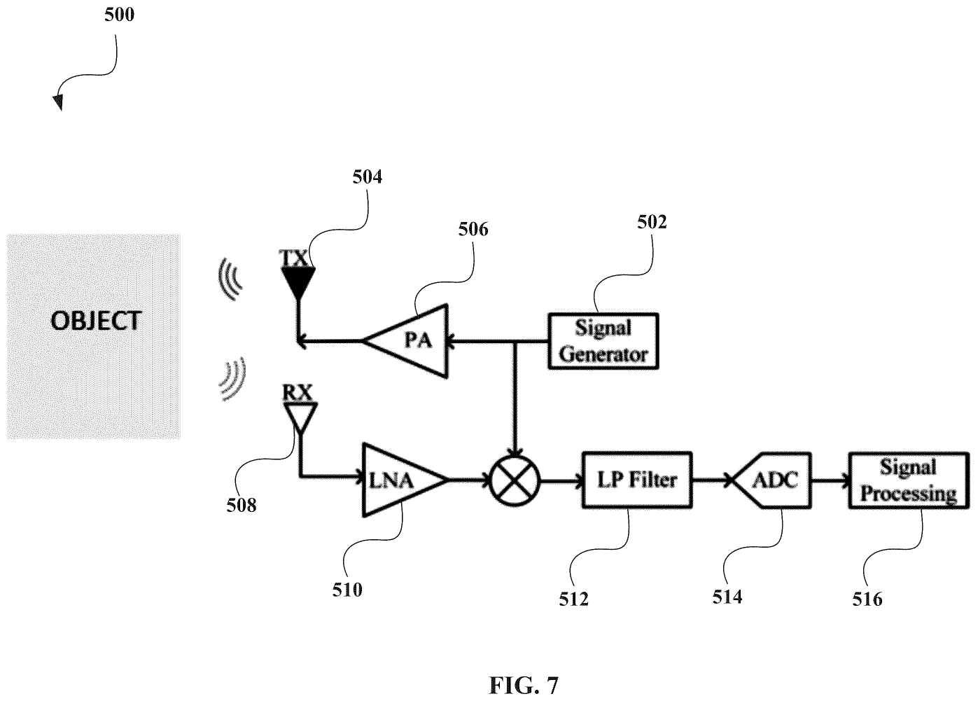

FIG. 7 shows the functional architecture of an example millimeter wave radar system 500. Chirp signals are commonly used in millimeter-wave scanners for their ability to provide range and velocity information simultaneously. It is characterized by a continuous frequency sweep, where the frequency of the signal increases or decreases linearly with time. This changing frequency enables the radar to detect objects at different distances and measure their velocity. Chirp frequency refers to the range of frequencies covered by the chirp signal during its transmission. By analyzing the time it takes for the transmitted chirp signal to bounce off objects and return to the scanner, the system can calculate the distance to those objects. The frequency information also allows the system to determine the velocity of the objects based on the Doppler effect.

In this example, the chirp signal is generated by the signal generator 502, and its frequency changes linearly with time:

$${f}_{t} = {f}_{0} + \frac{B}{{T}_{c}} t \qquad [ 1 ]$$

where fₜ, is the chirp frequency, f₀ is starting frequency, B is the chirp bandwidth (constant), and T_{c} is ramp time. The transmitted signal X_{T} is formulated as:

$${x}_{T} ( t ) = {A}_{T} cos cos ( 2 π {f}_{t} t + φ ( t ) ) \qquad [ 2 ]$$

where A_{T} is the transmit power and φ(t) is the phase noise.

Phase noise refers to random and unwanted fluctuations or variations in the phase of the transmitted or received signals. These fluctuations can be caused by various factors, including electronic components, environmental conditions, and interference. Phase noise can have a detrimental impact on the performance of millimeter-wave scanners, reducing the accuracy of distance and velocity measurements, decreasing the resolution of the system, and limiting its ability to detect and distinguish objects accurately. To maintain the reliability and precision of millimeter-wave scanners, phase noise is minimized through careful design, signal processing techniques, and quality control of components and subsystems.

The signal is transmitted through the transmitting antenna 504 via the power amplifier 506. The reflection from the transmitted signal (x_{R}(t)) is obtained at the receiving antenna 508 as:

$${x}_{R} ( t ) = {A}_{R} cos ( 2 π {f}_{t} ( t - {t}_{d} ) + φ ( t - {t}_{d} ) ) {t}_{d} = \frac{2 d ( t )}{c} \qquad [ 3 ]$$

where A_{R} is the signal amplitude, t_{d} is the delay between x_{R}(t) and the transmitted signal and c is the light speed (2.998×10⁸ m/s). The intermediate frequency (IF) signal can be obtained by applying low-pass filtering at low pass filter 512 after passing the signal through low noise amplifier 510:

$$s ( t ) = {Ae}^{j ( 2 π ( \frac{B}{{T}_{c}} {t}_{d} ) t + 2 π {f}_{0} {t}_{d} + π \frac{B}{{T}_{c}} {t}_{d}^{2} + Δφ ( t ) )} = {Ae}^{j ( 2 π {f}_{IF} t + {φ}_{b} ( t ) + Δφ ( t ) )} \qquad [ 4 ]$$

Where j is the imaginary mathematic parameter.

In this equation Δφ(t)=φ(t)−φ(t−t_{d}) and πBt_{d}²/T_{c} can be discarded. These terms can be discarded for short-range applications because they are considered small or negligible compared to other terms and have minimal impact on the overall behavior of the system. Therefore f_{IF}: can be written as

$${f}_{IF} = \frac{2 Bd ( t )}{{cT}_{c}} \qquad [ 5 ]$$

where d(t) is the distance between the antenna (either of the RX or TX antenna, which may be placed on a common surface) and an object. Also φ_{b} is:

$${φ}_{b} ( t ) = 2 π {f}_{0} {t}_{d} + \frac{π B}{{T}_{c}} {t}_{d}^{2} \qquad [ 6 ]$$

Therefore, the modified IF signal can be rewritten as:

$$s ( t ) = {Ae}^{j ( 2 π ( \frac{B}{{T}_{c}} {t}_{d} ) t + 2 π {f}_{0} {t}_{d} )} \qquad [ 7 ]$$

The signal passes through an analog-to-digital converter 514 and is obtained by signal processing subsystem 516. By taking Fast Fourier transform (FFT) of s(t), the signal frequency spectrum can be obtained which corresponds to the distance of the objects detected.

To acquire IR and US sensor data, an ATmega328P microcontroller mounted on an Arduino Uno was utilized. The analog signal of the IR sensor was sampled at 50 Hz. To read the US sensor data, a digital pin was triggered, and the generated ultrasound signal was received by the echo digital pin. The wave traveling time was measured and translated to displacement. The IR and US sensors data were transmitted to a PC using a UART (RS232) with a Baud rate of 115200 bps. The data transmission between the TI IWR1843BOOST radar system was done through establishing connection via two UART ports at 115200 bps and 921600 bps. The radar data was transmitted at 30 Hz (maximum allowable frame rate for mmWave TI IWR1843Boost Radar), then decoded and plotted in MATLAB 2021b in real-time.

For the FMCW millimeter wave radar sensor, distance measurement is done through FFT analysis where the signal range bins correspond to the distance of the objects detected. Therefore, the chirp signal parameters are tuned, as well as CFAR range and Doppler range thresholds, to be able to detect the desired objects. Table 1 lists the signal processing variables and chirp signal configurations tuned for this study to achieve the highest range resolution and maximize the likelihood of finding the human body-like (aluminum) surface.

TABLE 1

| Configurations | Values | |
|---|---|---|
| Frequency Start | 77 | GHz |
| Frequency Slope | 11.925 | MHz/μs |
| Frequency Slope Constant | 247 | |
| Sampling Rate | 3 | ksps |
| Idle Time | 7 | μs |

| | |
|---|---|
| ADC Valid Start Time | 6.4/μs |
| Ramp End Time | 329.4/μs |
| Chirp Cycle Time | 336.4/μs |
| No. of Samples per Chirp | 966 |
| No. of Chirp Loops | 17 |

| FMCW Radar Tuning Parameter | Value | |
|---|---|---|
| Start Parameter | 77 | GHz |
| Range Resolution | 0.039 | m |
| Maximum Detectable Range | 1.1 | m |
| Velocity Resolution | 0.12 | m/s |
| Maximum Velocity | 0.94 | m/s |
| Measurement Frequency (Frame Rate) | 30 | Hz |

The FMCW radar configurations are tuned to better find the hidden surfaces beyond the first-surface, at a trade-off with the ability to accurately estimate the first-surface, because the FMCW tuning configuration can be compensated by IR and US sensors to find the first-surface, representing the outer clothing layers, with the FMCW radar optimized to measure the distance to the inner layer, representing the user body surface. The bandwidth (bw) of the FMCW radar model (3.8 GHZ) determines the range resolution I of the radar and can be calculated as follows:

$$r = \frac{c}{( 2 bw )} = \frac{2.998 \times {10}^{8} [ \frac{m}{s} ]}{( 2 \times 3.8 \times {10}^{9} [ Hz ] )} = 0.039 m \qquad [ 10 ]$$

While this range resolution represents a fundamental hardware limitation, which sets the ultimate hidden-surface sensing resolution of the system, it is something that can be improved as hardware specifications improve (e.g., the TI AWR2943/445 FMCW radar sensor offers up to 5 GHz bandwidth, which would improve the resolution to 0.029 m, a 25.6% improvement through a simple hardware upgrade).

Given that the maximum FMCW radar resolution in this example is limited to 3.9 cm, and the notches in the test setup were spaced every 3 cm, some measurement errors due to the radar calibration settings and/or the characteristics of the materials that comprise the first- and hidden-surfaces are expected and can be accounted for. Initial testing is conducted to quantify the FMCW measurement error (both random and systematic error) with respect to the materials selected for testing (solid MDF, aluminum, and woven canvas fabric). In each trial, a specific material surface is placed a known distance from the FMCW radar, and range estimates are taken. The distance is systematically varied from 3 cm to 60 cm with a measurement taken at each distance (for a total of 20 measurements), and the trial is repeated 3 times (for an overall total of 60 measurements).

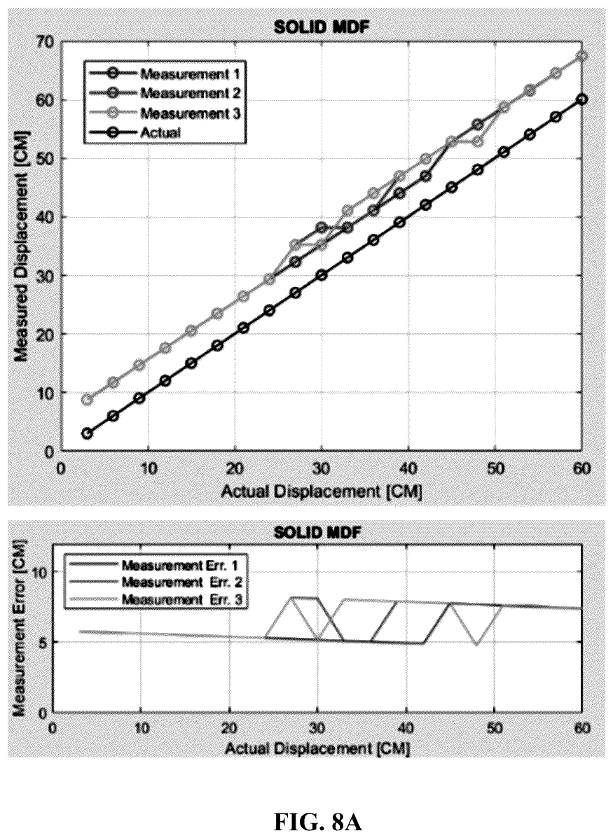

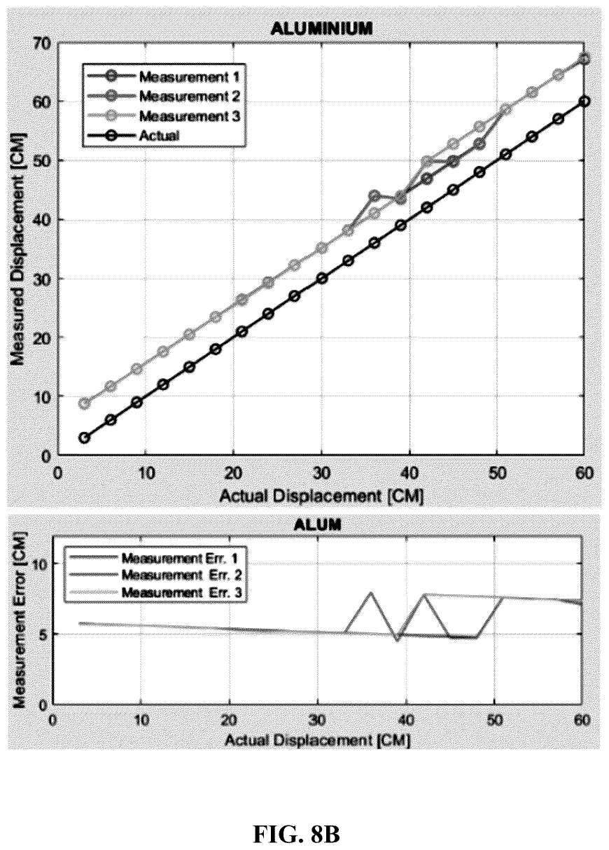

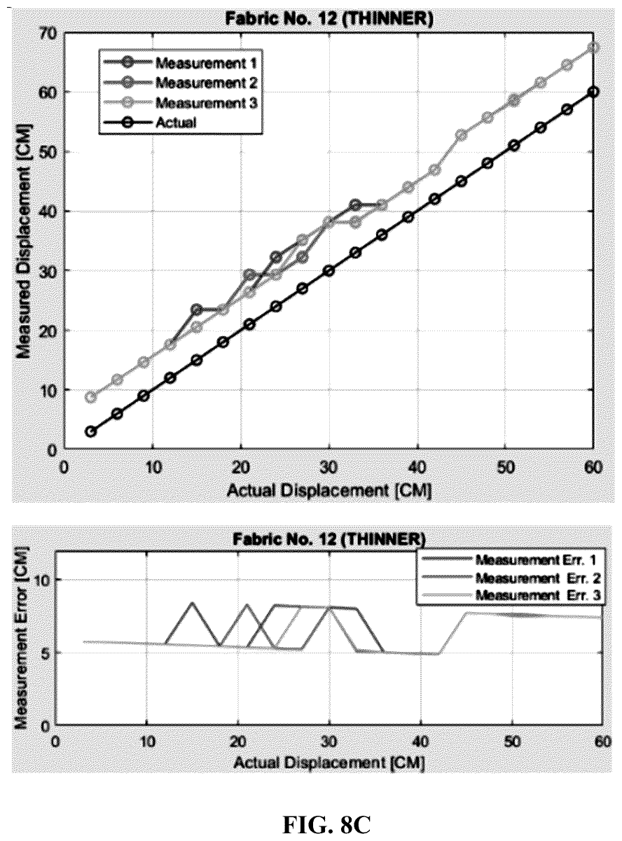

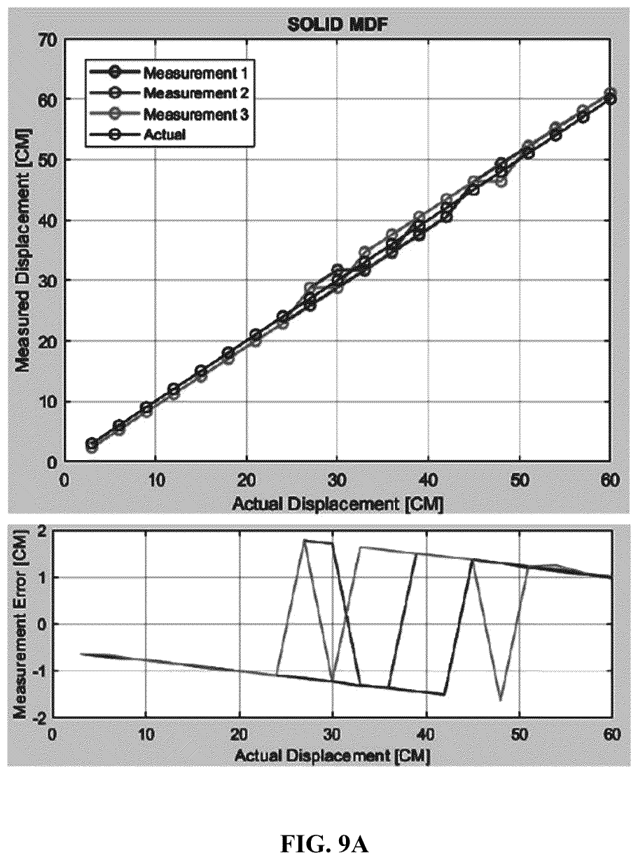

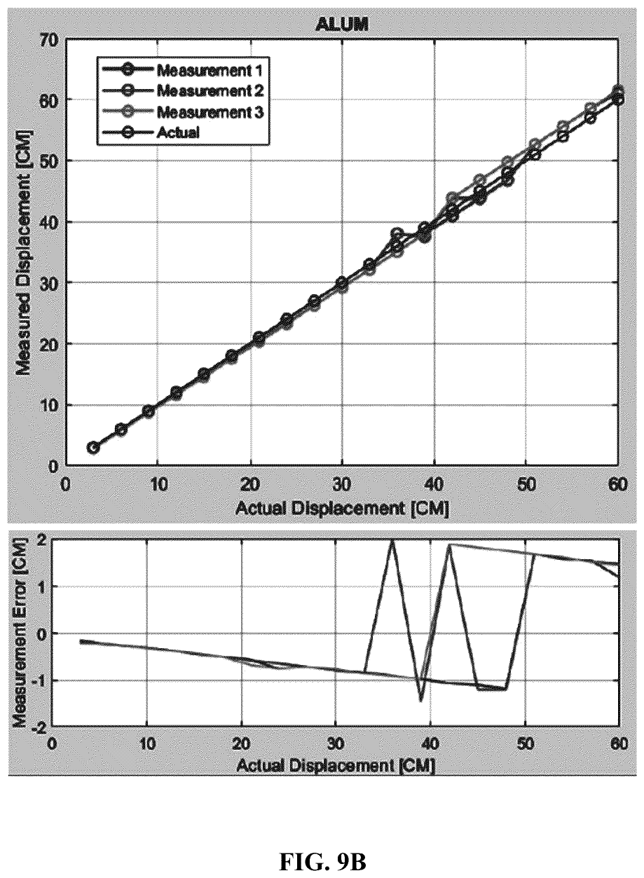

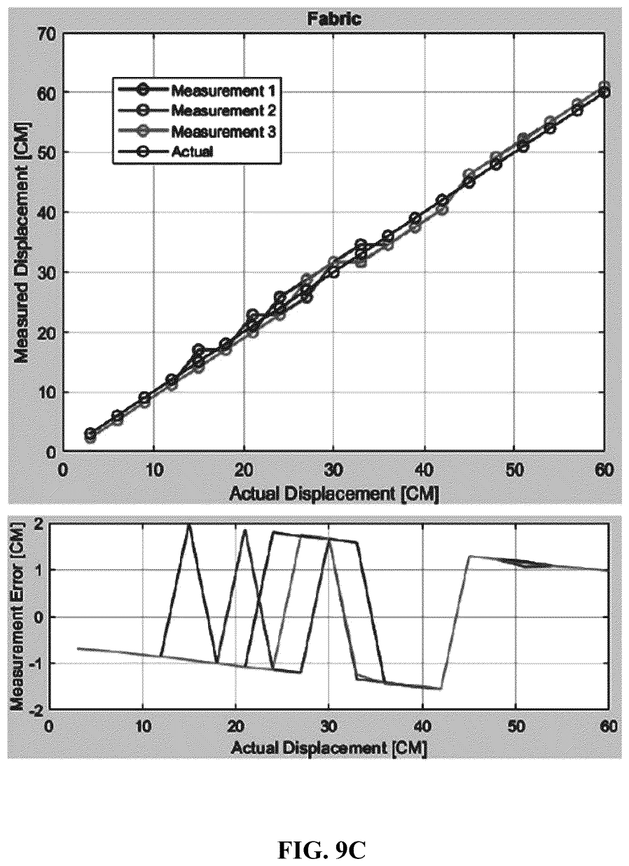

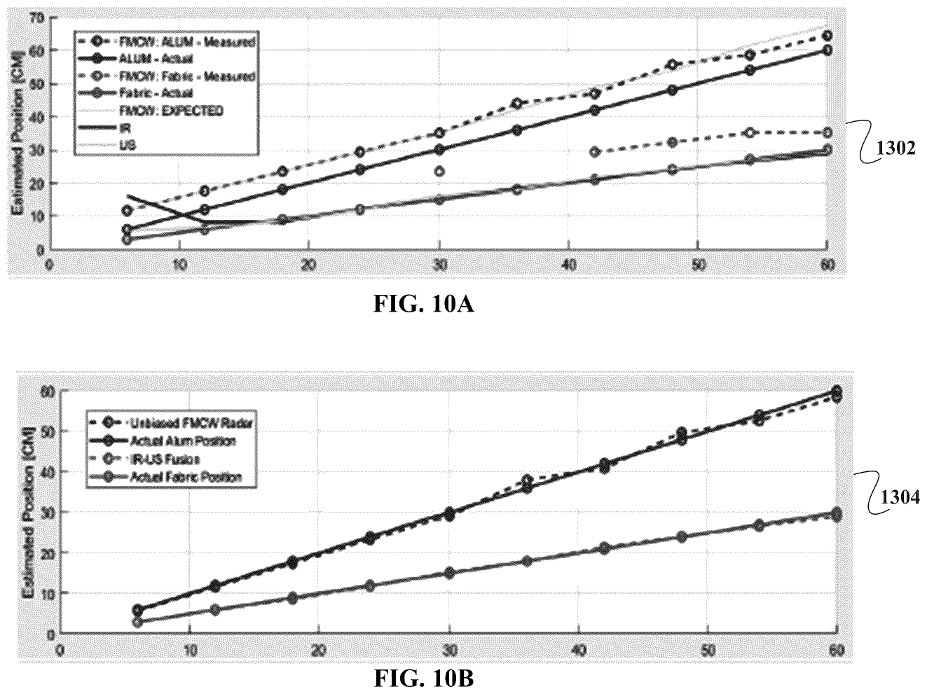

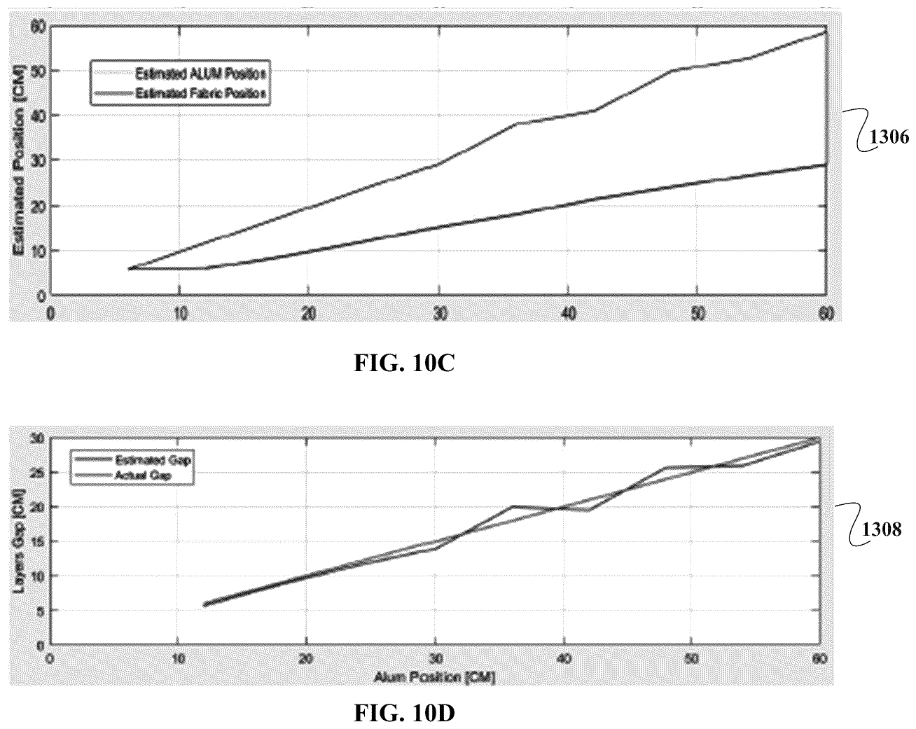

FIGS. 8A-8D are a series of graphs of the FMCW range of measurement errors. The graphs of FIGS. 9A-9C depict the difference between the measured range and the actual range which vary between 5 to 8 cm, which, in this example, is higher than the best-case scenario range resolution of 3.9 cm. This is attributable to an observed systematic error (e.g., offset) which is present in each test for each material. This systematic error can be eliminated through calibration, and is removed by subtracting the average error from each calibration test. FIGS. 10A-10D are a series of graphs of the corrected measurement of the FMCW range of measure of FIGS. 8A-8C.

With each sensor individually calibrated, it is possible to combine and cross-reference each signal to improve an overall system accuracy and to detect both first-surfaces and hidden-surfaces simultaneously. IR and US sensors can accurately estimate the distance to the first-surface (e.g., the fabric layer) using the range estimation equations derived from the calibration data in FIGS. 8A-8C and 9A-9C (equations 8 and 9, respectively) and the FMCW radar (once calibrated) can accurately estimate the distance to the hidden-surface, referring to the aluminum-coated MDF layer in the test setup. In order to reduce the IR/US estimation error, a logistic regression model (a 1-layer Multi-Layer-Perceptron Neural Network) may be trained to produce the correct fabric-based layer distance out of the two sensor measurements. Levenberg-Marquardt backpropagation may used to optimize the learning parameters. Having used this fusion technique, the estimation error is reduced to 0.041 cm (on the test set) from 0.1610 cm and 0.4728 cm for US and IR sensors, respectively.

With the system fully calibrated and with the sensor fusion strategy in place, tests are conducted to determine the capacity of the multi-band sensor system to measure the gap between the fabric and the human-skin-like surface. Using the above described test setup, simultaneous range measurements are taken of both a first-surface (woven canvas) and a hidden-surface placed behind it (aluminum coated MDF) with the distance to each systematically varied relative to the sensor suite. The IR/US sensors are utilized to measure the outer layer distance and the FMCW radar was adopted to find the aluminum plate position.

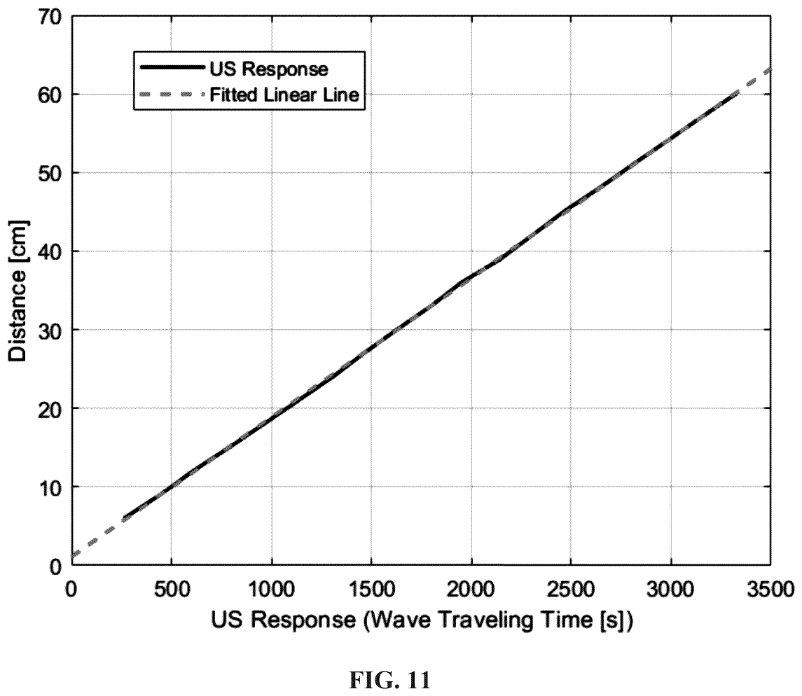

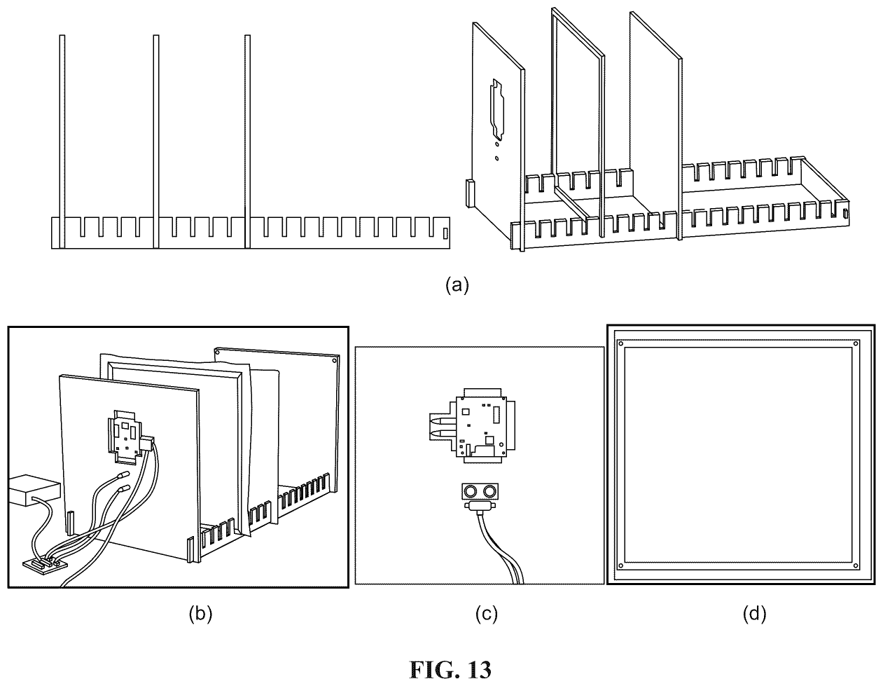

FIG. 11 is a plot of calibration measurement for the US sensors. The example calibration of FIG. 11 is presented in the context of the example gap measurement setup of FIG. 13. To characterize the range accuracy of the sensor fusion system at detecting both first- and hidden-surfaces simultaneously, a test setup to allow for variable placement of multiple surfaces relative to the sensor suite (which may be kept in a fixed location) is presented herein.

FIG. 13 includes CAD and the dimensions of the designed setup in Solidworks (FIG. 13 a); test setup and the sensor mounting frames (FIG. 13 b); radar & sensor suite (FIG. 13 c); and illustration of MDF first-surface frame with the test fabric mounted (FIG. 13 d). Three MDF frames are mounted on a set of common railings: one frame was permanently fixed in place, to hold the sensor suite; one movable empty frame, within which a fabric swatch could be mounted (to create the first-surface); and one movable solid frame covered in aluminum foil designed to approximate human skin as far as penetration or reflectivity within the mm wave spectrum (to create the hidden-surface). The common railings include 20 notches spaced every 3 cm, starting from 3 cm to 60 cm from the sensors mount, to allow for a systematic method to vary the distance of both the first- and hidden-surfaces relative to the sensor suite. The sensor mount allows all sensors to be placed along the centerline of the frame, and are spaced such that they did not interfere with each other vertically (FIG. 13 c). The test framework CAD can be designed in Solidworks (FIG. 13 a) and fabricated through laser cutting of a non-reflective 3 mm (⅛″) MDF. The empty frame (shown in FIG. 13 d) holds a layer of fabric firmly stretched vertically and horizontally to avoid wrinkling. A plain woven cotton fabric, such as cotton duck canvas (0.72 mm thickness), is an example of a clothing material that would leave gaps between the material and the body (as opposed to a knitted fabric, which would most likely fit closer to the body). The fabric specifications are included in Table 2.

TABLE 2

| Fabric | Fiber | | Sub- | | Weight | Thickness |
|---|---|---|---|---|---|---|
| Name | Content | Structure | structure | Sheen | (GSM) | (mm) |
| Cotton | 100% | Woven | Plain | No | 393 | 0.72 |
| duck | cotton | | weave: | | | |
| canvas | | | double fill | | | |

To calibrate the IR and US sensors, the non-reflective 6 mm thick MDF plate is placed in front of the sensors at progressively increasing distance—from notch 1 to 20 in the test setup of FIG. 13 (e.g., from 3 cm to 60 cm away from the sensor suite, in 3 cm increments). In total 20 measurements are performed.

The US sensor response is linearly modeled an RMSE distance estimation error of 0.1610 cm. Best fit distance estimation equations for the US sensor is:

$${d}_{US} = 1.775 \times {10}^{- 2} x + 1.1 \qquad [ 8 ]$$

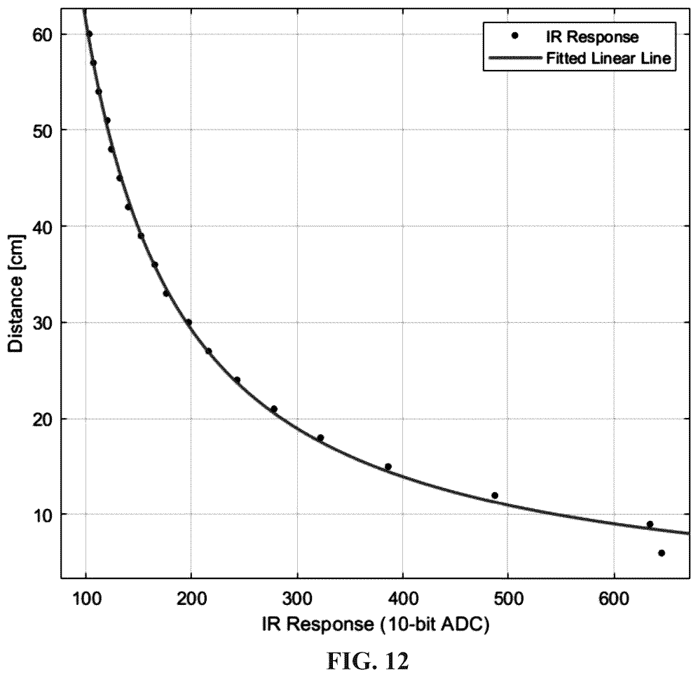

FIG. 12 is a plot of calibration measurement for the IR sensors. The IR sensor response is exponentially modeled with an RMSE of 0.4728 cm. Best fit distance estimation equations for the IR sensor is:

$${d}_{IR} = 188.936 {e}^{- 0.0181 x} + 38.4487 {e}^{- 0.0024 x} \qquad [ 9 ]$$

Taken together, under controlled settings both the US and IR sensor packages show sufficiently high distance estimation accuracy for use in this application.

In embodiments, scanners configured as described herein have the ability to capture two- and/or three-dimensional data. For example, by mounting the unit on an arm that can do horizontal and vertical sweeps around a stationary object, in some cases similar to the way airport scanners are used, or by placing the object to be scanned on a rotating platform so it can rotate while the scanning unit takes multiple measurements.

### EXAMPLES

### Example 1

In some embodiments, a triple frequency band remote measurement system that is based on, for example, a 77-81 GHz FCMW radar used as the millimeter wave scanner (e.g., 310 of FIG. 4) a 40 kHz Ultrasound sensor used as the US scanner (e.g., 308 of FIG. 4), and an Infrared 344 GHz distance sensor (e.g., 308 of FIG. 4), is used synergistically and allows for remote measurement of uniaxial distances to multiple layered surfaces simultaneously. This example can be validated with a test setup developed to mount multiple surfaces at variable distances from the sensor suite, and the sensor suite when activated can provide measurements at different configurations and distances from, for example, 3-60 cm. To provide a single measurement for the IR/US sensors, a logistic regression-based model is used (where, instead of picking a sensor, the data of both sensors is used to estimate the position at a better accuracy and less error), reducing the surface estimation error (RMSE) from 0.1610 cm and 0.4728 cm for US and IR sensors, respectively, to 0.041 cm. Results show that the current first-generation multi-sensor system is able to find the air-gap between a fabric surface and an underlying body-like surface with an RMSE of 1.1573 cm.

The specifications of each sensor model and category used in this example are summarized in Table 3.

TABLE 3

| | | | Sensor specifications | | | |
|---|---|---|---|---|---|---|
| Sensor | | | | Operating | Working | Communication |
| type | Vendor | Sensor Model | Range | voltage | frequency | protocol |
| FMCW | Texas | IWR 1843BOOST | >30 m | 5 v | 76-77 | UART |
| Radar | Instrument | | | | GHz & | (RS232) |
| | | | | | 77-81 | |
| | | | | | GHz | |
| Ultrasonic | Gearbox | HC-SR04 | 2- | 5 v | 40 kHz | Arduino |
| sensor | Labs | | 400 cm | | | UART |
| | | | | | | (RS232) |
| Infrared | Sharp | GP2Y0A221YK0F | 10- | 5 v | 344 | ADC → |
| | | | 80 cm | | GHz | Arduino |
| | | | | | | UART |
| | | | | | | (RS232) |

### Example 2

The sensor suite described in Example 1 affords multiple sensing modalities designed to detect both first surfaces (using IR and/or US sensors) and hidden surfaces (using millimeter wave sensors), which when combined can detect both surfaces simultaneously. Example 2 is directed to a sensor fusion approach.

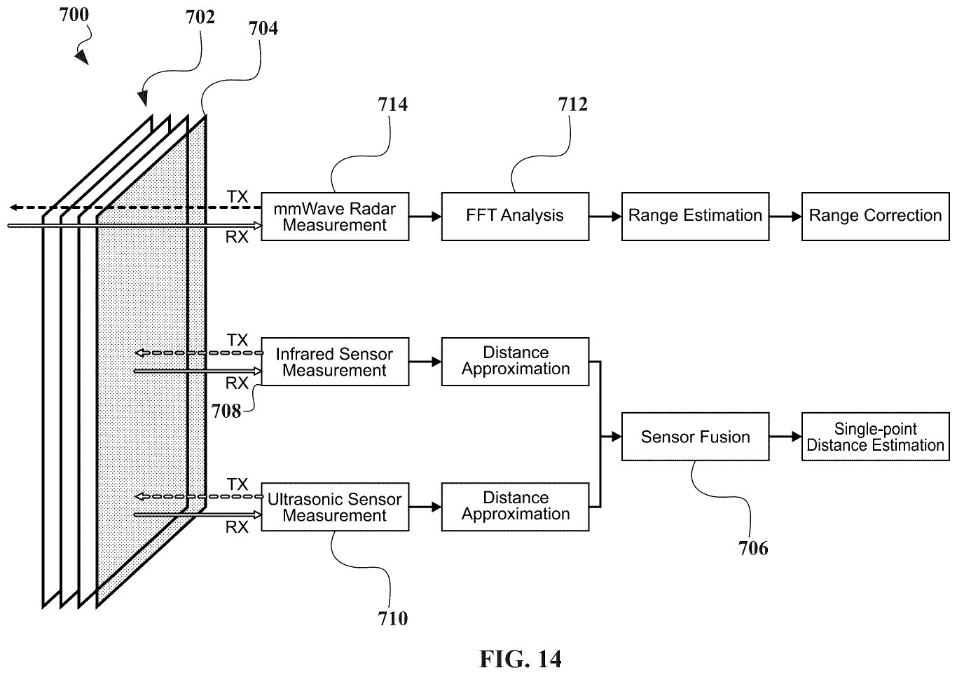

FIG. 14 is a diagram of the system of another example sensor fusion system 700. Both a first surface 704 and a hidden surface 702 are simultaneously detected. IR and US sensors can be combined for redundancy and error correction to accurately estimate distance to the first surface, and millimeter wave sensors can be processed to estimate distance to the hidden or obstructed surface. A sensor fusion element 706 acts on distance approximations received from each of an IR sensor 708 and a US sensor 710 to yield a single-point distance estimation. A Fast Fourier Transform (FFT) analysis 712 is used for signal processing from the millimeter wave sensor 714.

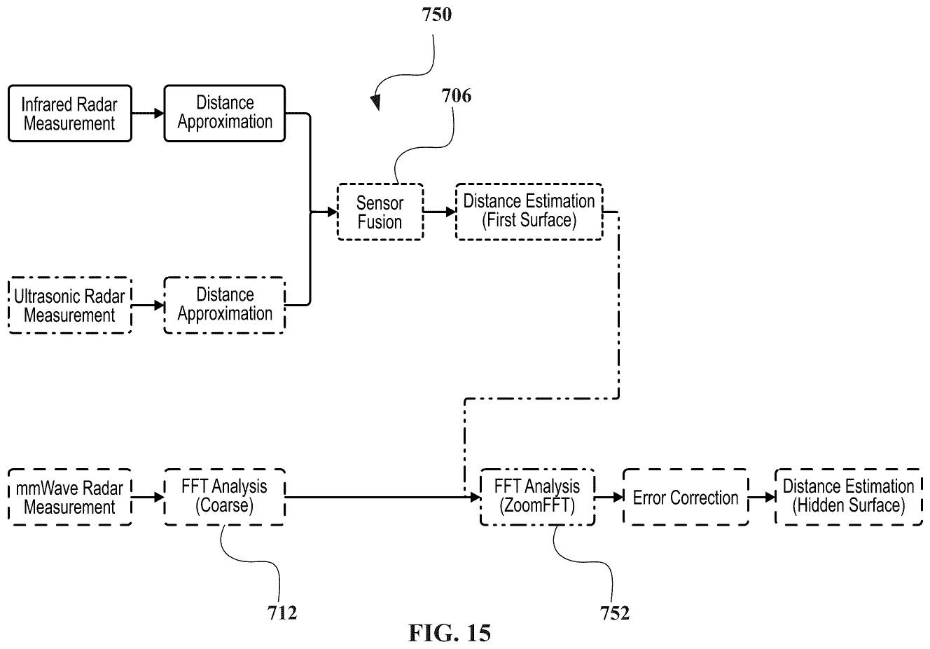

FIG. 15 is a block diagram of another example sensor fusion system 750. System 750 incorporates a second FFT analysis 752 downstream of the sensor fusion element 706 and the first FFT analysis 712. The second FFT analysis 752 takes the output of each of the sensor fusion element 706 and the first FFT analysis 712 to provide an improved distance estimation of the hidden surface. In embodiments, the second FFT analysis 752 is a Zoom FFT step is added. Zoom FFT is a signal processing technique used to analyze a portion of a spectrum at a high resolution.

Zoom FFT requires a window or range of distances on which to “zoom in.” Objects within the window are measured with greater accuracy. In this example, the first surface measurement is used to set the window for the zoom. For the purposes of measuring garments, setting the window just beyond the first surface measurement enables the system to more accurately capture the hidden surface in millimeter resolution. In examples, error in measurement of the second surface (surface 702 in FIG. 14) is reduced from centimeters to about 3-4 mm.

### Example 3

Example 3 is directed to a data acquisition system, and may be implemented in association with either of Example 1 or Example 2 above. To acquire IR and US sensor data, an ATmega328P microcontroller mounted on an Arduino Uno can be used. The analog signal of the IR sensor was sampled at 50 Hz. To read the US sensor data, a digital pin is triggered, and the generated ultrasound signal was received by the echo digital pin. The wave traveling time is measured and translated to displacement. The IR and US sensors data were transmitted to a PC using a UART (RS232) with a Baud rate of 115200 bps. The data transmission between the TI IWR1843BOOST radar system was done through establishing connection via two UART ports at 115200 bps and 921600 bps. The transmitted data are then decoded and plotted in MATLAB 2021b in real-time.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

What is claimed is:

1. A sensor system comprising:
a first emitter having a first type, and a first sensor having the first type;
a second emitter having a second type, and a second sensor having the second type, the first emitter, the first sensor, the second emitter, and the second sensor mechanically coupled to one another in a fixed positional relationship.

2. The sensor system of claim 1, further comprising a processor configured to:
cause the first emitter to emit a first signal;
receive data from the first sensor corresponding to a reflection of the first signal emitted by the first emitter,
receive data from the second sensor corresponding to a reflection of the second signal emitted by the second emitter,
perform a Fast Fourier transform of the signal frequency spectrum from the first sensor and from the second sensor to determine a first distance and a second distance, respectively; and
based upon a difference between the first distance and the second distance, determine an amount of an ease.

3. The sensor system of claim 2, wherein the first type is millimeter wave, the first emitter is a millimeter wave emitter, and the first sensor is a millimeter wave scanner.

4. The sensor system of claim 2, wherein the second type is infrared, the second emitter is an infrared light source, and the second sensor is an infrared camera.

5. The sensor system of claim 4, wherein the infrared light source has a variable wavelength.

6. The sensor system of claim 2, wherein the second type is ultrasound, the second emitter is an ultrasound emitter, and the second sensor is an ultrasound microphone.

7. The sensor system of claim 6, further comprising:
a third emitter having a third type, and a third sensor having the third type, the third sensor coupled to the first sensor and the second sensor in the fixed positional relationship.

8. The sensor system of claim 2, further comprising a display, wherein the processor is configured to determine the level of ease across an area and output a mapping of ease to the display.

9. The sensor system of claim 1, wherein the fixed positional relationship is colocation.

10. A method for measuring an ease between a positive ease garment and an internal structure, the method comprising:
emitting a first signal from a first emitter having a first type;
emitting a second signal from a second emitter having a second type;
collecting a reflection of the first signal at a first sensor having the first type;
collecting a reflection of the second signal at a second sensor having the second type;
performing a Fast Fourier transform of the signal frequency spectrum from the first sensor and from the second sensor to determine a first distance and a second distance, respectively; and
based upon a difference between the first distance and the second distance, determine an amount of the ease,
wherein the first sensor, the first emitter, the second sensor, and the second emitter are held in a fixed positional relationship.

11. The method of claim 10, wherein the first type is millimeter wave, the first emitter is a millimeter wave emitter, and the first sensor is a millimeter wave scanner.

12. The method of claim 10, wherein the second type is infrared, the second emitter is an infrared light source, and the second sensor is an infrared camera.

13. The method of claim 12, wherein the infrared light source has a variable wavelength.

14. The method of claim 10, wherein the second type is ultrasound, the second emitter is an ultrasound emitter, and the second sensor is an ultrasound microphone.

15. The method of claim 14, further comprising:
emitting a third signal from a third emitter having a third type; and
collecting a reflection of the third signal at a third sensor having the third type;
wherein the third sensor is mechanically coupled to the first sensor and the second sensor in the fixed positional relationship.

16. The method of claim 10, further comprising determining a level of the ease across an area and outputting a mapping of ease to a display.

17. The method of claim 10, wherein the fixed positional relationship is colocation.

18. The method of claim 10, further comprising training a logistic regression model to produce fabric-based layer distance corresponding to the determined amount of ease.

19. The method of claim 10, further comprising determining the amount of the ease continuously across an area to map ease as a function of time during a movement.

20. A system for measuring an ease between a positive ease garment and an internal structure comprising:
a sensor fusion unit comprising each of an infrared scanner and an ultrasonic scanner;
a millimeter wave scanner co-located with the sensor fusion unit; and
at least one processor in communication with a memory, the memory comprising instructions which, when executed by the processor, cause the processor to perform:
receiving a first flight time from the sensor fusion unit and a second flight time form the millimeter wave scanner;
determining a difference between the first flight time and the second flight time;
estimating, based on the difference between the first flight time and the second flight time, an amount of ease.
